(19) United States
(12) Patent Application Publication
(10) Pub. No.: US 2003/0045281 A1
(43) Pub. Date: Mar. 6, 2003

(54) Mobile transceiver state machine testing device

(76) Inventor: Yoram Rimoni, Haifa (IL)

Correspondence Address: QUALCOMM Incorporated, Attn: Patent Department, 5775 Morehouse Drive, San Diego, CA, 92121-1714, US

(21) Appl. No.: 10/119,286

(22) Filed: Apr. 8, 2002

Related U.S. Application Data
(60) Provisional application No. 60/282,665, filed on Apr. 9, 2001.

(51) Int. Cl. H04Q 7/20; H04M 1/00; H04B 1/38

(52) U.S. Cl. 455/424; 455/423; 455/561

(57) ABSTRACT

A method for simulating a communication system, including displaying a graphic representation of a state chart including a plurality of states and corresponding to a procedure followed by the communication system. The method also includes generating executable computer code responsive to the state chart, which code, when run by a simulator, causes the simulator to simulate the procedure. The method further includes incorporating into the computer code one or more pointers so as to generate, while the simulator is simulating the procedure, an indication in the graphic representation of the state in which the simulator is running.

### RELATED APPLICATIONS

This application claims priority to U.S. Provisional Patent Application No. 60/282,665, filed on Apr. 9, 2001.

### CROSS-REFERENCE TO RELATED APPLICATIONS

This application is related to a U.S. patent application entitled “Mobile System Testing Architecture,” filed on even date, which is assigned to the assignee of the present application and which is incorporated herein by reference.

### COMPUTER PROGRAM LISTING APPENDIX

This application includes one compact disc and one duplicate compact disc. The total number of compact discs including the duplicate is two. Each compact disc comprises 30 directories and 237 files incorporated within these directories. The names, dates of creation in day/month/year format, and size in bytes of each file on each compact disc are listed below, by directory. The material on the compact discs is incorporated herein by reference.

| | | |
|---|---|---|
| File Name | Date of Creation | Size in Bytes |

Directory of \koala (0 files)

| | | |
|---|---|---|
| — | — | 0 |

Directory of \koala\CU (0 files)

| | | |
|---|---|---|
| — | — | 0 |

Directory of \koala\CU\BML (0 files)

| | | |
|---|---|---|
| — | — | 0 |

Directory of \koala\CU\BML\chsm_compiler (6 files)

| | | |
|---|---|---|
| chsmToCpp.dsp | 14/08/00 | 6,524 |
| chsmToCpp.dsw | 05/09/00 | 541 |
| chsmToCpp.ncb | 25/01/01 | 99,328 |
| chsmToCpp.opt | 25/01/01 | 53,760 |
| updated_chsm.c | 20/03/00 | 7,702 |
| user_event.c | 14/08/00 | 8,575 |

Directory of \koala\CU\Chsm243 (10 files)

| | | |
|---|---|---|
| Changes | 17/06/99 | 78,882 |
| Copying | 17/06/99 | 18,321 |
| INSTALLATION | 17/06/99 | 5,512 |
| Makefile | 17/06/99 | 1,574 |
| README | 17/06/99 | 1,424 |
| VC_compiler_changes.txt | 04/10/99 | 1,372 |
| chsm.dsp | 17/06/99 | 1,760 |
| chsm.dsw | 04/10/99 | 1,809 |
| chsm.ncb | 25/01/01 | 246,784 |
| chsm.opt | 25/01/01 | 75,264 |

Directory of \koala\CU\Chsm243\bin (2 Files)

| | | |
|---|---|---|
| chsm | 21/06/99 | 9,021 |
| pthash | 21/06/99 | 2,476 |

Directory of \koala\CU\Chsm243\chsm2c (5 files)

| | | |
|---|---|---|
| chsm2c.dsp | 04/10/99 | 9,659 |
| chsm2c.dsw | 25/01/01 | 535 |
| chsm2c.exe | 20/03/00 | 884,790 |
| chsm2c.ncb | 25/01/01 | 173,056 |
| chsm2c.opt | 25/01/01 | 53,760 |

Directory of \koala\CU\Chsm243\config (8 files)

| | | |
|---|---|---|
| Makefile | 17/06/99 | 1,625 |
| config.SPARCompiler-Solaris2 | 17/06/99 | 8,173 |
| config.g++ | 17/06/99 | 8,338 |
| config.gcc.h | 21/06/99 | 1,086 |
| config.mk | 21/06/99 | 8,334 |
| config.sh | 17/06/99 | 2,583 |
| config.vc6.h | 17/06/99 | 1,085 |
| man.mk | 17/06/99 | 1,633 |

Directory of \koala\CU\Chsm243\config\src (14 files)

| | | |
|---|---|---|
| ansi_cpp.c | 17/06/99 | 501 |
| bool.c | 17/06/99 | 179 |
| const_initializer.c | 17/06/99 | 355 |
| explicit.c | 17/06/99 | 231 |
| logical_keywords.c | 17/06/99 | 257 |
| mutable.c | 17/06/99 | 238 |
| namespaces.c | 17/06/99 | 757 |
| nested_templates.c | 17/06/99 | 300 |
| new_casts.c | 17/06/99 | 253 |
| nonpublic_class.c | 17/06/99 | 317 |
| static_function.c | 17/06/99 | 510 |
| template_static.c | 17/06/99 | 352 |
| template_typedef.c | 17/06/99 | 338 |
| variant_virtual.c | 17/06/99 | 307 |

Directory of \koala\CU\Chsm243\Debug (0 files)

| | | |
|---|---|---|
| — | — | 0 |

Directory of \koala\CU\Chsm243\examples (6 files)

| | | |
|---|---|---|
| Makefile | 21/06/99 | 1,282 |
| dynamic.chsm | 21/06/99 | 1,121 |
| h2o.chsm | 21/06/99 | 1,659 |
| hello.chsm | 21/06/99 | 178 |
| microwave.chsm | 21/06/99 | 6,391 |
| vending.chsm | 21/06/99 | 3,321 |

Directory of \koala\CU\Chsm243\include (5 files)

| | | |
|---|---|---|
| Makefile | 21/06/99 | 1,907 |
| chsm.h | 21/06/99 | 19,399 |
| chsm_queue.h | 21/06/99 | 5,566 |
| dynamic_chsm.h | 21/06/99 | 4,457 |
| unistd.h | 04/10/99 | 164 |

Directory of \koala/CU\Chsm243\include\pjl (16 files)

| | | |
|---|---|---|
| compiler.h | 04/10/99 | 7,612 |
| hash.c | 21/06/99 | 3,625 |
| hash.h | 04/10/99 | 10,261 |
| hashX.h | 04/10/99 | 10,408 |
| link2.h | 21/06/99 | 2,340 |
| newaware.c | 21/06/99 | 1,041 |
| newaware.h | 21/06/99 | 2,189 |
| pointer.h | 21/06/99 | 7,343 |
| progen.h | 21/06/99 | 2,189 |
| registry.c | 21/06/99 | 503 |
| registry.h | 21/06/99 | 10,532 |
| rtti.h | 21/06/99 | 2,143 |
| serial.c | 21/06/99 | 1,077 |
| serial.h | 21/06/99 | 2,309 |
| symbol.h | 04/10/99 | 8,742 |
| symbolX.h | 04/10/99 | 8,739 |

Directory of \koala\CU\Chsm243\include\pjl\util (6 files)

| | | |
|---|---|---|
| config.gcc.h | 21/06/99 | 1,086 |
| config.h | 17/06/99 | 100 |
| config.vc6.h | 04/10/99 | 1,214 |
| fakeansi.h | 04/10/99 | 3,115 |
| hashpjw.h | 21/06/99 | 1,178 |
| itoa.h | 21/06/99 | 1,242 |

Directory of \koala\CU\Chsm243\lib (0 files)

| | | |
|---|---|---|
| — | — | 0 |

Directory of \koala\CU\Chsm243\man (1 file)

| | | |
|---|---|---|
| Makefile | 21/06/99 | 11,107 |

Directory of \koala\CU\Chsm243\man\man1 (7 files)

| | | |
|---|---|---|
| Makefile | 21/06/99 | 1,144 |
| chsm.1 | 21/06/99 | 5,609 |
| chsm.pdf | 21/06/99 | 7,566 |
| chsm.txt | 21/06/99 | 4,776 |
| chsm2c++.1 | 21/06/99 | 4,349 |
| chsm2c++.pdf | 21/06/99 | 5,867 |
| chsm2c++.txt | 21/06/99 | 3,429 |

Directory of \koala\CU\Chsm243\man\man3 (59 files)

| | | |
|---|---|---|
| CHSM.3 | 21/06/99 | 5,451 |
| CHSM.pdf | 21/06/99 | 7,315 |
| CHSM.txt | 21/06/99 | 5,178 |
| Makefile | 21/06/99 | 2,110 |
| RTTI.3 | 21/06/99 | 2,366 |
| RTTI.pdf | 21/06/99 | 3,902 |
| RTTI.txt | 21/06/99 | 1,773 |
| any_registrant.3 | 21/06/99 | 21 |
| any_registry.3 | 21/06/99 | 21 |
| cluster.3 | 21/06/99 | 2,985 |
| cluster.pdf | 21/06/99 | 4,651 |
| cluster.txt | 21/06/99 | 2,364 |
| compiler.3 | 21/06/99 | 11,119 |
| compiler.pdf | 21/06/99 | 14,734 |
| compiler.txt | 21/06/99 | 11,265 |
| dynamic_parent.3 | 21/06/99 | 3,004 |
| dynamic_parent.pdf | 21/06/99 | 4,503 |
| dynamic_parent.txt | 21/06/99 | 2,414 |
| dynamic_set.3 | 21/06/99 | 3,721 |
| dynamic_set.pdf | 21/06/99 | 5,253 |
| dynamic_set.txt | 21/06/99 | 3,357 |
| dynamic_state.3 | 21/06/99 | 2,571 |
| dynamic_state.pdf | 21/06/99 | 3,563 |
| dynamic_state.txt | 21/06/99 | 1,952 |
| event.3 | 21/06/99 | 5,687 |
| event.pdf | 21/06/99 | 7,591 |
| event.txt | 21/06/99 | 4,925 |
| itoa.3 | 21/06/99 | 1,469 |
| itoa.pdf | 21/06/99 | 2,611 |
| itoa.txt | 21/06/99 | 722 |
| link2.3 | 21/06/99 | 3,057 |
| link2.pdf | 21/06/99 | 4,823 |
| link2.txt | 21/06/99 | 2,395 |
| ltoa.3 | 21/06/99 | 17 |
| new_aware.3 | 21/06/99 | 1,988 |
| new_aware.pdf | 21/06/99 | 3,238 |
| new_aware.txt | 21/06/99 | 1,209 |
| parent.3 | 21/06/99 | 3,208 |
| parent.pdf | 21/06/99 | 4,712 |
| parent.txt | 21/06/99 | 2,612 |
| progenitor.3 | 21/06/99 | 3,463 |
| progenitor.pdf | 21/06/99 | 5,273 |
| progenitor.txt | 21/06/99 | 2,948 |
| pt_link2.3 | 21/06/99 | 18 |
| pt_list_link2.3 | 21/06/99 | 18 |
| registrant.3 | 21/06/99 | 21 |
| registry.3 | 21/06/99 | 10,734 |
| registry.pdf | 21/06/99 | 12,827 |
| registry.txt | 21/06/99 | 10,408 |
| serial_number.3 | 21/06/99 | 2,775 |
| serial_number.pdf | 21/06/99 | 3,713 |
| serial_number.txt | 21/06/99 | 2,198 |
| serial_number_base.3 | 21/06/99 | 26 |
| set.3 | 21/06/99 | 2,269 |
| set.pdf | 21/06/99 | 3,383 |
| set.txt | 21/06/99 | 1,488 |
| state.3 | 21/06/99 | 4,777 |
| state.pdf | 21/06/99 | 6,711 |
| state.txt | 21/06/99 | 4,453 |

Directory of \koala\CU\Chsm243\man\man4 (4 files)

| | | |
|---|---|---|
| Makefile | 21/06/99 | 1,089 |
| chsm.4 | 21/06/99 | 20,807 |
| chsm.pdf | 21/06/99 | 26,672 |
| chsm.txt | 21/06/99 | 20,669 |

Directory of \koala\CU\Chsm243\src (1 file)

| | | |
|---|---|---|
| Makefile | 21/06/99 | 1,195 |

Directory of \koala\CU\Chsm243\src\bin (1 file)

| | | |
|---|---|---|
| Makefile | 21/06/99 | 1,197 |

Directory of \koala\CU\Chsm243\src\bin\chsm2c++ (39 files)

| | | |
|---|---|---|
| Makefile | 21/06/99 | 6,085 |
| base.c | 21/06/99 | 1,779 |
| base.h | 21/06/99 | 3,800 |
| child.c | 21/06/99 | 1,861 |
| child.h | 21/06/99 | 1,560 |
| chsm.c | 21/06/99 | 6,967 |
| chsm.h | 04/10/99 | 3,696 |
| cluster.c | 21/06/99 | 1,936 |
| cluster.h | 21/06/99 | 1,640 |
| event.c | 21/06/99 | 3,265 |
| event.h | 04/10/99 | 2,632 |
| global.c | 21/06/99 | 956 |
| global.h | 21/06/99 | 1,513 |
| grammar.c | 04/10/99 | 80,309 |
| grammar.y | 04/10/99 | 48,024 |
| lex.h | 21/06/99 | 2,023 |
| lex.l | 04/10/99 | 12,353 |
| lex.yy.c | 04/10/99 | 56,402 |
| main.c | 04/10/99 | 7,671 |
| main.h | 04/10/99 | 2,728 |
| mangle.c | 21/06/99 | 2,240 |
| mangle.h | 21/06/99 | 1,578 |
| manip.h | 04/10/99 | 2,340 |
| param_data.c | 21/06/99 | 2,915 |
| param_data.h | 04/10/99 | 3,839 |
| parent.c | 21/06/99 | 4,345 |
| parent.h | 04/10/99 | 2,117 |
| parent_data.h | 21/06/99 | 1,346 |
| set.c | 21/06/99 | 1,741 |
| set.h | 21/06/99 | 1,499 |
| smart_comma.h | 21/06/99 | 1,734 |
| state.c | 21/06/99 | 4,527 |
| state.h | 04/10/99 | 3,696 |
| templates.c | 04/10/99 | 1,498 |
| tokens.h | 04/10/99 | 657 |
| transition.c | 21/06/99 | 2,037 |
| transition.h | 04/10/99 | 1,912 |
| user_event.c | 21/06/99 | 7,965 |
| user_event.h | 04/10/99 | 2,598 |

Directory of \koala\CU\Chsm243\src\bin\hashsym (2 files)

| | | |
|---|---|---|
| Makefile | 21/06/99 | 1,263 |
| hashsym.c | 21/06/99 | 1,857 |

Directory of \koala\CU\Chsm243\src\lib (1 file)

| | | |
|---|---|---|
| Makefile | 21/06/99 | 1,105 |

Directory of \koala\CU\Chsm243\src\lib\chsm (4 files)

| | | |
|---|---|---|
| ChsmLib.dsp | 04/10/99 | 3,186 |
| Makefile | 21/06/99 | 1,798 |
| chsm.c | 21/06/99 | 20,827 |
| chsm_queue.c | 21/06/99 | 2,610 |

Directory of \koala\CU\Chsm243\src\lib\dynamic_chsm (4 files)

| | | |
|---|---|---|
| Dynamic_chsm.dsp | 21/06/99 | 3,072 |
| Makefile | 21/06/99 | 2,528 |
| dynamic_chsm.c | 21/06/99 | 2,754 |
| pt.c | 21/06/99 | 1,882 |

Directory of \koala\CU\Chsm243\src\lib\flex (4 files)

| | | |
|---|---|---|
| flex.dsp | 21/06/99 | 2,958 |
| libmain.c | 17/06/99 | 282 |
| libyywrap.c | 17/06/99 | 197 |
| libyywrapX.c | 04/10/99 | 208 |

Directory of \koala\CU\Chsm243\src\lib\pjl (10 files)

| | | |
|---|---|---|
| Makefile | 21/06/99 | 3,429 |
| PJL.dsp | 21/06/99 | 3,249 |
| compiler.c | 04/10/99 | 9,151 |
| hash.c | 04/10/99 | 7,340 |
| hashpjw.c | 21/06/99 | 1,310 |
| itoa.c | 21/06/99 | 1,442 |
| link2.c | 21/06/99 | 1,147 |
| pt.c | 21/06/99 | 1,944 |
| registry.c | 21/06/99 | 4,386 |
| symbol.c | 04/10/99 | 5,046 |

Directory of \koala\CU\Chsm243\tests (19 files)

| | | |
|---|---|---|
| Makefile | 21/06/99 | 1,447 |
| dominance.chsm | 21/06/99 | 705 |
| enter_deep.chsm | 04/10/99 | 655 |
| enter_exit.chsm | 04/10/99 | 695 |
| enter_once.chsm | 04/10/99 | 1,158 |
| erroneous1.chsm | 04/10/99 | 754 |
| erroneous2.chsm | 04/10/99 | 753 |
| events1.chsm | 04/10/99 | 962 |
| events2.chsm | 04/10/99 | 1,352 |
| events3.chsm | 04/10/99 | 1,350 |
| events4.chsm | 04/10/99 | 939 |
| finite.chsm | 04/10/99 | 515 |
| history.chsm | 04/10/99 | 658 |
| infinite.chsm | 21/06/99 | 575 |
| internal.chsm | 04/10/99 | 371 |
| microstep1.chsm | 04/10/99 | 595 |
| microstep2.chsm | 04/10/99 | 742 |
| nondeterminism.chsm | 04/10/99 | 534 |
| precondition.chsm | 21/06/99 | 858 |

Directory of \Visio (3 files)

| | | |
|---|---|---|
| KOALA StateCharts.vst | 21/08/00 | 406,528 |
| KoalaStateChartsAddOn.vsl | 21/08/00 | 61,440 |
| Qi-UML Statechart.vss | 21/08/00 | 43,520 |

### FIELD OF THE INVENTION

The present invention relates generally to mobile communications, and specifically to mobile transceiver testing systems.

### BACKGROUND OF THE INVENTION

Testing systems for mobile communication products are known in the art. For example, Tektronix Inc., of Portland, Oreg., produces a CMD80 digital communications test set which simulates a mobile communications operating environment and makes measurements on a mobile transceiver unit coupled to the CMD80. In the CMD80, a user is able to define test parameters of a network, such as a mean power and variations of the power of a signal from a base station, and measure the effects on a mobile combined transceiver. A mobile transceiver is herein termed a mobile.

U.S. Pat. No. 5,809,108 to Thompson, et al., whose disclosure is incorporated herein by reference, describes a test system for a mobile telephone. The system captures signaling data from the origination and termination sides of test calls. A test case generator builds new test calls by presenting to a user a menu for each step in the new test call. The user creates test calls by selecting list items and by entering keyboard data related to the item where appropriate.

U.S. Pat. No. 5,862,383 to Laitinen, whose disclosure is incorporated herein by reference, describes a method for generating code of a protocol for driving a digital signal processor in a communications system. The system employs a computer having a display presenting a series of blocks representative of elements of a message. Data entered into the computer includes identification of various message elements for inclusion in the display. This provides for a graphical representation of bit streams following the protocol. The computer converts the graphical representation, via Transfer Syntax Notation (TSN) language, to machine language for operation of the digital signal processor.

U.S. Pat. No. 5,875,397 to Sasin, et al., whose disclosure is incorporated herein by reference, describes apparatus and a method for testing telephone communications equipment. The test apparatus includes a central signal processor and a programmable data processor for the generation of digital test signals for testing the telephone communications equipment. There is a converter connected with the programmable data processor. The converter is constructed so that it converts the digital test signals of the data processor, under the control of telephone specific configuration data, into signals for controlling the operation of the keypad and of the microphone of the telephone via a connector. The converter also converts answer signals received from the loudspeaker and from the calling apparatus of the telephone into digital operating answer signals and transfers the signals to the programmable data processor, where they are saved or evaluated.

U.S. Pat. No. 6,011,830 to Sasin, et al., whose disclosure is incorporated herein by reference, describes a test device and a method of executing a test for a system which can assume a number of operating states. The device is stated to be particularly suitable for testing a mobile telephone network, such as a Global System for Mobile (GSM) communications network, e.g. for interrupting connection lines therein. A test case generator is provided for generating a number of test cases which are sent via a test device interface to the system under test. A test state model of the system is formulated by a test state model generator using information on the hardware configuration and other parameters of the system. Test commands are generated on the basis of a Monte-Carlo simulation of this test state model.

Methods for automatically producing software code based on graphic elements such as flow charts are known in the art. For example, Visio 2000 SR1, produced by Microsoft Corporation of Seattle, Wash., is a graphic package which enables the generation of code, in a number of computer languages some of which follow UML (Universal Modeling Language) format, from a graphic representation of a state machine. The package comprises an interface via which attributes for different sections of a state machine can be defined.

The M. S. Thesis of Paul J. Lucas (University of Illinois at Urbana-Champaign, technical report: UIUCCS-R-94-1868), which is incorporated herein by reference, describes a language for implementing a Concurrent Hierarchical State Machine (CHSM). The CHSM language is a text-based language for specifying state charts. A state chart is a formal method for graphically specifying a state machine. State charts have an advantage compared with state transition diagrams, in that the charts comprise child and parent states. A version CHSM 2.4.3 of the language, by Lucas & Riccardi, can be found at http://homepage.mac.com/pauljlucas/software.html, and files for the version are included in the Computer Program Listing Appendix.

### SUMMARY OF THE INVENTION

It is an object of some aspects of the present invention to provide an improved method and apparatus for testing a mobile communication system.

It is a further object of some aspects of the present invention to provide an improved method and apparatus for converting a graphic element to computer executable code.

It is another object of some aspects of the present invention to provide an animated graphical user interface for testing a communication system.

In preferred embodiments of the present invention, a user of a mobile communications simulator generates a state chart representing a procedure followed by a base station controller (BSC) comprised in a cellular communications network. The procedure is carried out by a test station which simulates the operation of the BSC. The state chart is most preferably generated using a commercial software product which is capable of exporting the chart as computer code that is relatively easy to modify. The exported code is converted to executable code, most preferably using a commercial compiler and assembler. Before conversion, an operator of the test station modifies the exported code, by combining it with input produced by the operator. This added step of modifying the automatically-generated code enables the operator of the test station to design more flexible procedures than those which may be produced without the operator produced input.

In preferred embodiments of the present invention, the chart is also implemented as an animated state chart, which displays a state of a unit under test (UUT) during a test of the UUT. During the test, the animated chart displays which state or states are operative, transitions to and from operative states, and events causing the transitions. Most preferably, a history of the test is maintained. Further most preferably, the test operator is able to incorporate one or more graphical breakpoints at one or more states and/or one or more transitions into the graphic of the state chart. The operator most preferably incorporates the breakpoints in the course of modifying the exported code. Using an animated state chart gives the operator of the test system good visual feedback, enabling the operator to follow the progress of a specific test in a simple manner. Using graphical breakpoints within the animated state chart also allows the operator to interact simply with the unit under test.

There is therefore provided, according to a preferred embodiment of the present invention, a method for simulating a communication system, including:

displaying a graphic representation of a state chart including a plurality of states and corresponding to a procedure followed by the communication system;

generating executable computer code responsive to the state chart, which code, when run by a simulator, causes the simulator to simulate the procedure; and

incorporating into the computer code one or more pointers so as to generate, while the simulator is simulating the procedure, an indication in the graphic representation of the state in which the simulator is running.

Preferably, the communication system includes a Base Station Controller (BSC) and the method includes:

coupling a unit-under-test (UUT) to the simulator; and

conveying communications between the UUT and the simulator while the simulator is simulating the procedure of the BSC.

Preferably, conveying the communications between the UUT and the simulator includes operating the UUT responsive to the indication in the graphic representation.

Preferably, the method includes receiving a signal from the simulator and generating a display responsive to the signal on the monitor.

Preferably, generating executable code includes:

generating code automatically under control of operating instructions for a computing system; and

incorporating code generated by an operator of the communication system in the automatically generated code.

Preferably, the state chart includes a first state chart and a second state chart, and displaying the graphic representation includes:

displaying the first state chart; and

displaying the second state chart responsive to the indication displayed on the first start chart.

There is further provided, according to a preferred embodiment of the present invention, apparatus for simulating a communication system, including:

a computing system, adapted to generate a graphic representation of a state chart including a plurality of states and corresponding to a procedure followed by the communication system, and which is further adapted to generate executable computer code responsive to the state chart and to incorporate one or more pointers indicative of respective one or more of the plurality of states in the code;

a simulator which is adapted to simulate the procedure responsive to the executable computer code, and to generate, responsive to the one or more pointers, an indication of the state in which the simulator is running; and

a monitor, which is coupled to the simulator so as to display the graphic representation with the indication of the state in which the simulator is running.

Preferably, the communication system includes a Base Station Controller (BSC), and the simulator includes a processor and a memory which are adapted to simulate operations of the BSC, and the simulator is adapted to communicate with a unit-under-test (UUT) while simulating the procedure.

Preferably, the UUT is operated responsive to the indication of the state in which the simulator is running.

Preferably, the monitor is adapted to receive a signal from the simulator and to generate a display responsive to the signal on the monitor.

Preferably, the computing system is adapted to generate code automatically under control of operating instructions for the processor, and to incorporate code generated by an operator of the computing system in the automatically generated code.

Preferably, the state chart includes a first state chart and a second state chart, and the simulator is adapted to cause the monitor to display the first state chart and to display the second state chart responsive to the indication displayed on the first start chart.

The present invention will be more fully understood from the following detailed description of the preferred embodiments thereof, taken together with the drawings, in which:

### BRIEF DESCRIPTION OF THE DRAWINGS

FIGS. 1A and 1B are state charts of procedures followed by a test station used for evaluating performance of a mobile telephone, according to a preferred embodiment of the present invention;

FIG. 2 is a flowchart showing steps involved in a graphic-to-code conversion process, according to a preferred embodiment of the present invention; and

FIG. 3 is a schematic block diagram showing how code generated as described with respect to FIG. 2 is utilized, according to a preferred embodiment of the present invention.

### DETAILED DESCRIPTION OF PREFERRED EMBODIMENTS

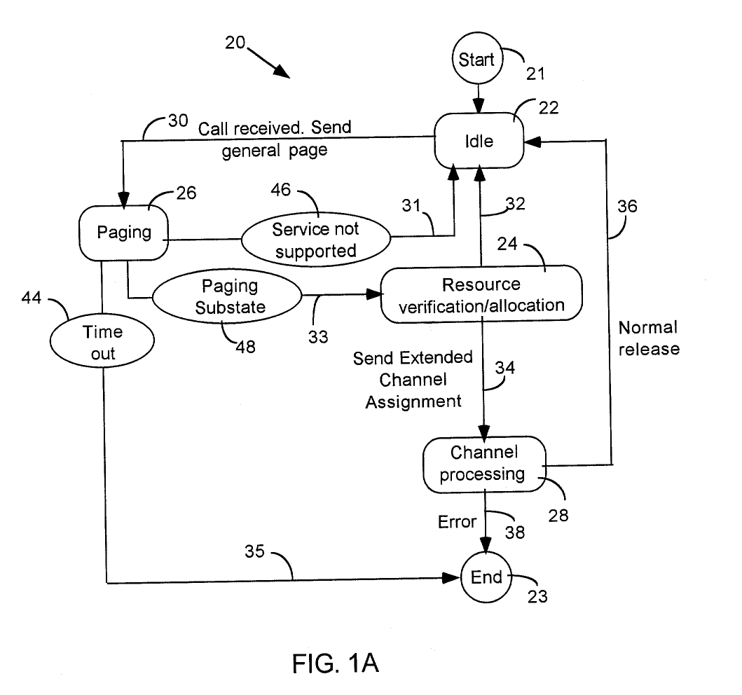

Reference is now made to FIGS. 1A and 1B, which are state charts of procedures followed by a test station used for evaluating performance of a mobile telephone, herein termed a mobile, according to a preferred embodiment of the present invention. The test station most preferably simulates signals and procedures generated by one or more base station controllers (BSCs). An example of a suitable test station is described in the U.S. patent application entitled “Mobile System Testing Architecture,” referenced hereinabove and filed on even date. The state charts of FIGS. 1A and 1B are preferably implemented using a commercial software program, such as Visio Enterprise, which is able to generate computer code corresponding to the charts.

FIG. 1A represents a state chart 20 showing states 21, 22, 23, 24, 26, and 28 in which one of the BSCs being simulated can exist when a call from a PSTN (public switched telephone network) telephone to a mobile is received by the BSC. States 26 and 28 are composite states, as described in more detail below with reference to FIG. 1B. Transitions 30, 31, 32, 33, 34, 35, 36, and 38 connect states 21, 22, 23, 24, 26, and 28. Connectors 44, 46, and 48 are graphic elements comprising transition connections, which are not entities of the state chart itself. State chart 20 comprises initial state 21 and final state 23. If, while the BSC is in idle state 22, it receives a land-based call from a PSTN telephone, transition 30 to composite paging state 26 occurs and a general page message is sent from the BSC to the specific mobile called by the land-based telephone. The page message informs the mobile that a call has been received, and comprises a specification of a type of service, typically voice service, required by the BSC.

FIG. 1B is a state chart showing states and transitions comprised in composite paging state 26. State 26 comprises a WaitingForPageConfirm state 42, wherein the BSC waits for confirmation that the mobile has received the general paging message. Once confirmation is received, the BSC enters a paging substate 40, wherein it waits for a response to the page from the mobile. The BSC exits from paging substate 40 via one of three paths. In a first time out path 52, the BSC transfers through Timeout connector 44 to final state 23 of the procedure. Path 52 is followed if the BSC is in paging substate 40 longer than a predetermined time. In a second path 54, the BSC returns to idle state 22 via ServiceNotSupported connector 46. Path 54 is followed if the BSC is not able to provide services for the call to be completed.

A third path 56 via PagingSubstate connector 48 is followed if the mobile is able to answer the general page message and if the BSC receives a page response from the mobile indicating this. In this case, the BSC transfers to VerifyResourceAllocation state 24. In state 24 the BSC checks that resources in the form of traffic channels are available for the call, allocates the resources, and sends an Extended Channel Assignment Message (ECAM) to the mobile. The BSC then transfers via transition 34 to an MTTCH channel processing state 28, wherein the BSC remains while the call proceeds. When the call is terminated, the assigned traffic channel is released and the BSC returns to idle state 22 via transition 36. If while the call is proceeding the call is unable to continue, for example if the mobile does not acknowledge signals sent to it, the call setup procedure terminates via transition 38.

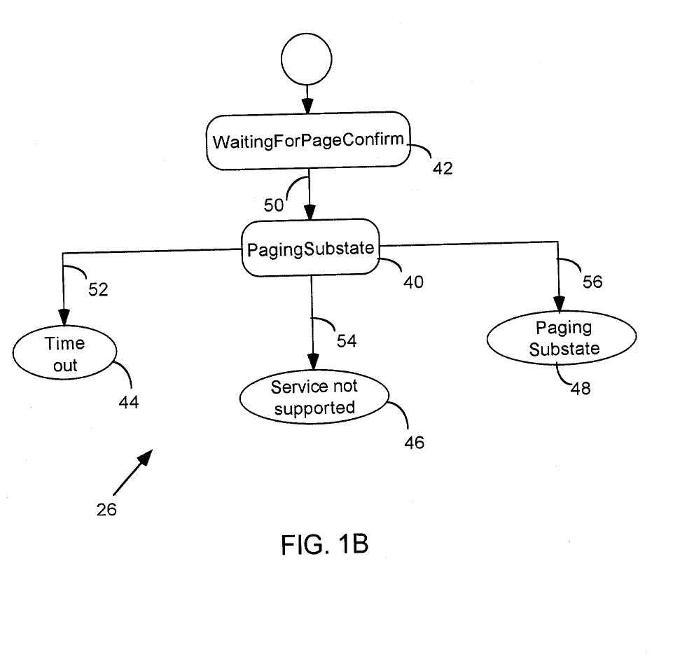

FIG. 2 is a flowchart showing steps involved in a graphic-to-code conversion process, according to a preferred embodiment of the present invention. The process is implemented by any suitable industry-standard computing system. In an initial step a state chart, similar to state chart 20, is constructed as described above with reference to FIGS. 1A and 1B. The state chart corresponds to a procedure or a partial procedure followed by the BSC. When the state chart is constructed, attributes are defined for each state and each transition. At least some attributes are preferably defined using an interface associated with each state and each transition. An example of an interface for defining attributes is that provided in Visio Enterprise, as described in the Background off the Invention. Attributes which are not defined using the interface are referenced so that they can be defined later in the conversion process, as described below. Most preferably, at least some attributes correspond to operator-removable breakpoints, which breakpoints can be utilized by a system operator to follow and interact with the procedure being simulated.

After the state chart has been constructed, regions on the chart which are to be animated when the procedure is implemented by a simulator are added to the chart. Once the state chart has been constructed, it is converted to code corresponding to a UML format. This code is then used in an animation code path.

In the animation code path, the code is used to generate animated state chart code. The animated state chart code is then converted to executable code which is able to display an animation of the state chart on a display monitor. Most preferably, the animation comprises a graphical indication of which states and transitions a procedure has already invoked and is in the process of invoking, corresponding to a history of the simulation. Further most preferably, the animation comprises a graphical indication when a breakpoint is invoked. The process of displaying the animation is described in more detail below.

In a simulation code path, the UML format code is parsed and converted to CHSM code, and the CHSM code is then compiled to a standard language such as C++. In preferred embodiments of the present invention, the process of parsing, converting, then compiling is performed using the following software packages:

Microsoft Visio 2000 SR1 (6.0.2027) produced by Microsoft Corporation, of Seattle, Wash.;

Microsoft Visual C++ 6.0, produced by Microsoft Corporation; and

CHSM 2.4.3, by Lucas & Riccardi, which can be found at: http://homepage.mac.com/pauljlucas/software.html, and a copy of which files are in the Koala\CU\CHSM243 folder of the compact disc provided as the computer program listing appendix of this application.

In order to parse the UML format code, using Visio 2000, the three files \Visio\KOALA StateCharts.vst, \Visio\Qi-UML Statechart.vss, and \Visio\KoalaStateChartsAddOn.vsl should be copied, from the compact disc incorporated herein as the computer program listing appendix, into Visio's Software folder. (The folder is usually located at C:\Program Files\Visio\Solutions\Software.) The “MISSING: computer program listing appendix VISXDATA 1.0 Type Library” entry, in the References—Visio_Model_Diagram dialog, should be unchecked. (To ensure the entry is unchecked, enter the Visual Basic for Applications Editor, and reset by clicking “Run” then “Reset.” In the “Tools” menu choose “References.”) Once the three files have been copied as described above, the Visio software package may be used to parse then convert the code.

In order to compile the converted code to C++, a modified version of the original CHSM to C++ compiler is used. The original version can be found in the koala\CU\Chsm243 folder of the compact disc. The modified version can be found in the koala\CU\BML\chsm_compiler folder. The modified version of the compiler can be built using the Visual C++ project—koala\CU\BML\chsm_compiler\chsmToCpp.dsp.

In a parallel operation, external supporting code, in a standard language such as C++, is generated to support attributes which have not been defined by the chart interface, but which have been referenced in the initial stage. The supporting code is included in the compiled CHSM code utilizing references incorporated at the initial stage. The animated chart executable code is also included at this point. The combined code is then compiled and converted to simulator executable code. The simulator executable code operates the procedure or partial procedure on a simulator used to test a mobile, herein termed a unit under test (UUT).

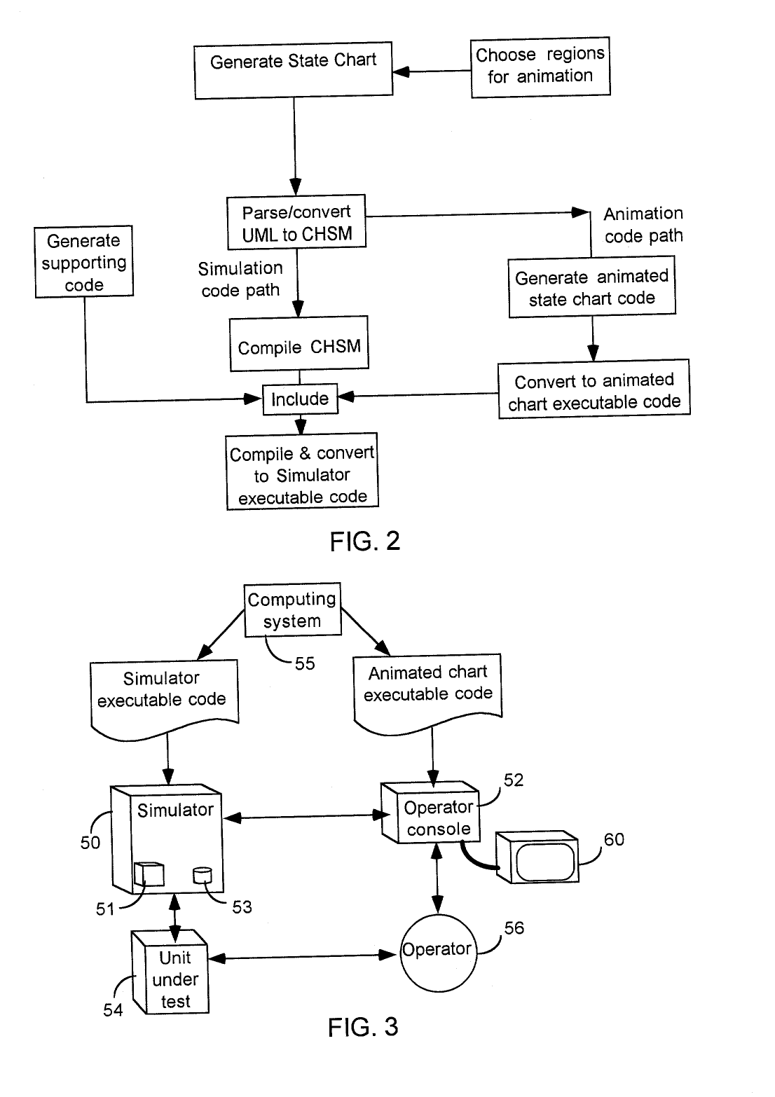

FIG. 3 is a schematic block diagram showing how code generated as described with respect to FIG. 2 is utilized, according to a preferred embodiment of the present invention. A simulator 50 is coupled to a UUT 54 and to an operator console 52. The simulator preferably comprises a computer processor 51 and a memory 53 which stores the simulator executable code. The simulator executable code, which is generated by a computing system 55 as described with reference to FIG. 2, is implemented by processor 51 on the simulator. Memory 53 most preferably further stores code which is utilized by processor 51 to simulate substantially all operations of a BSC, such as allocation and monitoring of communication channels between the BSC and UUT 54. The animation executable code is implemented on the operator console 52, and an operator 56 is able to interact with simulator 50 via the console.

During a simulation, simulator 50 uses its simulator code to perform procedures corresponding to the code. In parallel, simulator 50 provides data, in the form of one or more signals, to console 52 indicative of which transitions and/or states simulator 50 is in during the procedures being followed. Console 52 uses the data provided by simulator 50 in order to display the transitions being followed and/or the states the simulator is in. The transitions and states are displayed in an animated form on a graphic of the state chart of the procedure being followed. The animated graphic is generated on a display monitor 60 coupled to console 52. While viewing the animation, operator 56 is able to interact with simulator 50 via console 52. For example, the operator is able to repeat all or part of the procedure being followed, or to invoke another procedure to run on simulator 50. Operator 56 is also able to utilize breakpoints which have been incorporated as described above in order to interact with the procedure being simulated on simulator 50, including, for example, invoking another procedure which has been generated according to the graphic-to-code process described hereinabove.

It will be appreciated that the preferred embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

List of files contained on the CD-R

| | | |
|---|---|---|
| File Name | Date of Creation | Size in Bytes |

Directory of \koala (0 files)

| | | |
|---|---|---|
| — | — | 0 |

Directory of \koala\CU (0 files)

| | | |
|---|---|---|
| — | — | 0 |

Directory of \koala\CU\BML (0 files)

| | | |
|---|---|---|
| — | — | 0 |

Directory of \koala\CU\BML\chsm_compiler (6 files)

| | | |
|---|---|---|
| chsmToCpp.dsp | 14/08/00 | 6,524 |
| chsmToCpp.dsw | 05/09/00 | 541 |
| chsmToCpp.ncb | 25/01/01 | 99,328 |
| chsmToCpp.opt | 25/01/01 | 53,760 |
| updated_chsm.c | 20/03/00 | 7,702 |
| user_event.c | 14/08/00 | 8,575 |

Directory of \koala\CU\Chsm243 (10 files)

| | | |
|---|---|---|
| Changes | 17/06/99 | 78,882 |
| Copying | 17/06/99 | 18,321 |
| INSTALLATION | 17/06/99 | 5,512 |
| Makefile | 17/06/99 | 1,574 |
| README | 17/06/99 | 1,424 |
| VC_compiler_changes.txt | 04/10/99 | 1,372 |
| chsm.dsp | 17/06/99 | 1,760 |
| chsm.dsw | 04/10/99 | 1,809 |
| chsm.ncb | 25/01/01 | 246,784 |
| chsm.opt | 25/01/01 | 75,264 |

Directory of \koala\CU\Chsm243\bin (2 Files)

| | | |
|---|---|---|
| chsm | 21/06/99 | 9,021 |
| pthash | 21/06/99 | 2,476 |

Director of \koala\CU\Chsm243\chsm2c (5 files)

| | | |
|---|---|---|
| chsm2c.dsp | 04/10/99 | 9,659 |
| chsm2c.dsw | 25/01/01 | 535 |
| chsm2c.exe | 20/03/00 | 884,790 |
| chsm2c.ncb | 25/01/01 | 173,056 |
| chsm2c.opt | 25/01/01 | 53,760 |

Directory of \koala\CU\Chsm243\config (8 files)

| | | |
|---|---|---|
| Makefile | 17/06/99 | 1,625 |
| config.SPARCompiler-Solaris2 | 17/06/99 | 8,173 |
| config.g++ | 17/06/99 | 8,338 |
| config.gcc.h | 21/06/99 | 1,086 |
| config.mk | 21/06/99 | 8,334 |
| config.sh | 17/06/99 | 2,583 |
| config.vc6.h | 17/06/99 | 1,085 |
| man.mk | 17/06/99 | 1,633 |

Directory of \koala\CU\Chsm243\config\src (14 files)

| | | |
|---|---|---|
| ansi_cpp.c | 17/06/99 | 501 |
| bool.c | 17/06/99 | 179 |
| const_initializer.c | 17/06/99 | 355 |
| explicit.c | 17/06/99 | 231 |
| logical_keywords.c | 17/06/99 | 257 |
| mutable.c | 17/06/99 | 238 |
| namespaces.c | 17/06/99 | 757 |
| nested_templates.c | 17/06/99 | 300 |
| new_casts.c | 17/06/99 | 253 |
| nonpublic_class.c | 17/06/99 | 317 |
| static_function.c | 17/06/99 | 510 |
| template_static.c | 17/06/99 | 352 |
| template_typedef.c | 17/06/99 | 338 |
| variant_virtual.c | 17/06/99 | 307 |

Directory of \koala\CU\Chsm243\Debug (0 files)

| | | |
|---|---|---|
| — | — | 0 |

Directory of \koala\CU\Chsm243\examples (6 files)

| | | |
|---|---|---|
| Makefile | 21/06/99 | 1,282 |
| dynamic.chsm | 21/06/99 | 1,121 |
| h2o.chsm | 21/06/99 | 1,659 |
| hello.chsm | 21/06/99 | 178 |
| microwave.chsm | 21/06/99 | 6,391 |
| vending.chsm | 21/06/99 | 3,321 |

Directory of \koala\CU\Chsm243\include (5 files)

| | | |
|---|---|---|
| Makefile | 21/06/99 | 1,907 |
| chsm.h | 21/06/99 | 19,399 |
| chsm_queue.h | 21/06/99 | 5,566 |
| dynamic_chsm.h | 21/06/99 | 4,457 |
| unistd.h | 04/10/99 | 164 |

Directory of \koala\CU\Chsm243\include\pjl (16 files)

| | | |
|---|---|---|
| compiler.h | 04/10/99 | 7,612 |
| hash.c | 21/06/99 | 3,625 |
| hash.h | 04/10/99 | 10,261 |
| hashX.h | 04/10/99 | 10,408 |
| link2.h | 21/06/99 | 2,340 |
| newaware.c | 21/06/99 | 1,041 |
| newaware.h | 21/06/99 | 2,189 |
| pointer.h | 21/06/99 | 7,343 |
| progen.h | 21/06/99 | 2,189 |
| registry.c | 21/06/99 | 503 |
| registry.h | 21/06/99 | 10,532 |
| rtti.h | 21/06/99 | 2,143 |
| serial.c | 21/06/99 | 1,077 |
| serial.h | 21/06/99 | 2,309 |
| symbol.h | 04/10/99 | 8,742 |
| symbolX.h | 04/10/99 | 8,739 |

Directory of \koala\CU\Chsm243\include\pjl\util (6 files)

| | | |
|---|---|---|
| config.gcc.h | 21/06/99 | 1,086 |
| config.h | 17/06/99 | 100 |
| config.vc6.h | 04/10/99 | 1,214 |
| fakeansi.h | 04/10/99 | 3,115 |
| hashpjw.h | 21/06/99 | 1,178 |
| itoa.h | 21/06/99 | 1,242 |

Directory of \koala\CU\Chsm243\lib (0 files)

| | | |
|---|---|---|
| — | — | 0 |

Directory of \koala\CU\Chsm243\man (1 file)

| | | |
|---|---|---|
| Makefile | 21/06/99 | 1,107 |

Directory of \koala\CU\Chsm243\man\man1 (7 files)

| | | |
|---|---|---|
| Makefile | 21/06/99 | 1,144 |
| chsm.1 | 21/06/99 | 5,609 |
| chsm.pdf | 21/06/99 | 7,566 |
| chsm.txt | 21/06/99 | 4,776 |
| chsm2c++.1 | 21/06/99 | 4,349 |
| chsm2c++.pdf | 21/06/99 | 5,867 |
| chsm2c++.txt | 21/06/99 | 3,429 |

Directory of \koala\CU\Chsm243\man\man3 (59 files)

| | | |
|---|---|---|
| CHSM.3 | 21/06/99 | 5,451 |
| CHSM.pdf | 21/06/99 | 7,315 |
| CHSM.txt | 21/06/99 | 5,178 |
| Makefile | 21/06/99 | 2,110 |
| RTTI.3 | 21/06/99 | 2,366 |
| RTTI.pdf | 21/06/99 | 3,902 |
| RTTI.txt | 21/06/99 | 1,773 |
| any_registrant.3 | 21/06/99 | 21 |
| any_registry.3 | 21/06/99 | 21 |
| cluster.3 | 21/06/99 | 2,985 |
| cluster.pdf | 21/06/99 | 4,651 |
| cluster.txt | 21/06/99 | 2,364 |
| compiler.3 | 21/06/99 | 11,119 |
| compiler.pdf | 21/06/99 | 14,734 |
| compiler.txt | 21/06/99 | 11,265 |
| dynamic_parent.3 | 21/06/99 | 3,004 |
| dynamic_parent.df | 21/06/99 | 4,503 |
| dynamic_parent.txt | 21/06/99 | 2,414 |
| dynamic_set.3 | 21/06/99 | 3,721 |
| dynamic_set.pdf | 21/06/99 | 5,253 |
| dynamic_set.txt | 21/06/99 | 3,357 |
| dynamic_state.3 | 21/06/99 | 2,571 |
| dynamic_state.pdf | 21/06/99 | 3,563 |
| dynamic_state.txt | 21/06/99 | 1,952 |
| event.3 | 21/06/99 | 5,687 |
| event.pdf | 21/06/99 | 7,591 |
| event.txt | 21/06/99 | 4,925 |
| itoa.3 | 21/06/99 | 1,469 |
| itoa.pdf | 21/06/99 | 2,611 |
| itoa.txt | 21/06/99 | 722 |
| link2.3 | 21/06/99 | 3,057 |
| link2.pdf | 21/06/99 | 4,823 |
| link2.txt | 21/06/99 | 2,395 |
| ltoa.3 | 21/06/99 | 17 |
| new_aware.3 | 21/06/99 | 1,988 |
| new_aware.pdf | 21/06/99 | 3,238 |
| new_aware.txt | 21/06/99 | 1,209 |
| parent.3 | 21/06/99 | 3,208 |
| parent.pdf | 21/06/99 | 4,712 |
| parent.txt | 21/06/99 | 2,612 |
| progenitor.3 | 21/06/99 | 3,463 |
| progenitor.pdf | 21/06/99 | 5,273 |
| progenitor.txt | 21/06/99 | 2,948 |
| pt_link2.3 | 21/06/99 | 18 |
| pt_list_link2.3 | 21/06/99 | 18 |
| registrant.3 | 21/06/99 | 21 |
| registry.3 | 21/06/99 | 10,734 |
| registry.pdf | 21/06/99 | 12,827 |
| registry.txt | 21/06/99 | 10,408 |
| serial_number.3 | 21/06/99 | 2,775 |
| serial_number.pdf | 21/06/99 | 3,713 |
| serial_number.txt | 21/06/99 | 2,198 |
| serial_number_base.3 | 21/06/99 | 26 |
| set.3 | 21/06/99 | 2,269 |
| set.pdf | 21/06/99 | 3,383 |
| set.txt | 21/06/99 | 1,488 |
| state.3 | 21/06/99 | 4,777 |
| state.pdf | 21/06/99 | 6,711 |
| state.txt | 21/06/99 | 4,453 |

Directory of \koala\CU\Chsm243\man\man4 (4 files)

| | | |
|---|---|---|
| Makefile | 21/06/99 | 1,089 |
| chsm.4 | 21/06/99 | 20,807 |
| chsm.pdf | 21/06/99 | 26,672 |
| chsm.txt | 21/06/99 | 20,669 |

Directory of \koala\CU\Chsm243\src (1 file)

| | | |
|---|---|---|
| Makefile | 21/06/99 | 1,195 |

Directory of \koala\CU\Chsm243\src\bin (1 file)

| | | |
|---|---|---|
| Makefile | 21/06/99 | 1,197 |

Directory of \koala\CU\Chsm243\src\bin\chsm2c++ (39 files)

| | | |
|---|---|---|
| Makefile | 21/06/99 | 6,085 |
| base.c | 21/06/99 | 1,779 |
| base.h | 21/06/99 | 3,800 |
| child.c | 21/06/99 | 1,861 |
| child.h | 21/06/99 | 1,560 |
| chsm.c | 21/06/99 | 6,967 |
| chsm.h | 04/10/99 | 3,696 |
| cluster.c | 21/06/99 | 1,936 |
| cluster.h | 21/06/99 | 1,640 |
| event.c | 21/06/99 | 3,265 |
| event.h | 04/10/99 | 2,632 |
| global.c | 21/06/99 | 956 |
| global.h | 21/06/99 | 1,513 |
| gralnmar.c | 04/10/99 | 80,309 |
| grammar.y | 04/10/99 | 48,024 |
| lex.h | 21/06/99 | 2,023 |
| lex.l | 04/10/99 | 12,353 |
| lex.yy.c | 04/10/99 | 56,402 |
| main.c | 04/10/99 | 7,671 |
| main.h | 04/10/99 | 2,728 |
| mangle.c | 21/06/99 | 2,240 |
| mangle.h | 21/06/99 | 1,578 |
| manip.h | 04/10/99 | 2,340 |
| param_data.c | 21/06/99 | 2,915 |
| param_data.h | 04/10/99 | 3,839 |
| parent.c | 21/06/99 | 4,345 |
| parent.h | 04/10/99 | 2,117 |
| parent_data.h | 21/06/99 | 1,346 |
| set.c | 21/06/99 | 1,741 |
| set.h | 21/06/99 | 1,499 |
| smart_comma.h | 21/06/99 | 1,734 |
| state.c | 21/06/99 | 4,527 |
| state.h | 04/10/99 | 3,696 |
| templates.c | 04/10/99 | 1,498 |
| tokens.h | 04/10/99 | 657 |
| transition.c | 21/06/99 | 2,037 |
| transition.h | 04/10/99 | 1,912 |
| user_event.c | 21/06/99 | 7,965 |
| user_event.h | 04/10/99 | 2,598 |

Directory of \koala\CU\Chsm243\src\bin\hashsym (2 files)

| | | |
|---|---|---|
| Makefile | 21/06/99 | 1,263 |
| hashsym.c | 21/06/99 | 1,857 |

Directory of \koala\CU\Chsm243\src\lib (1 file)

| | | |
|---|---|---|
| Makefile | 21/06/99 | 1,105 |

Directory of \koala\CU\Chsm243\src\lib\chsm (4 files)

| | | |
|---|---|---|
| ChsmLib.dsp | 04/10/99 | 3,186 |
| Makefile | 21/06/99 | 1,798 |
| chsm.c | 21/06/99 | 20,827 |
| chsm_queue.c | 21/06/99 | 2,610 |

Directory of \koala\CU\Chsm243\src\lib\dynamic_chsm (4 files)

| | | |
|---|---|---|
| Dynamic_chsm.dsp | 21/06/99 | 3,072 |
| Makefile | 21/06/99 | 2,528 |
| dynamic_chsm.c | 21/06/99 | 2,754 |
| pt.c | 21/06/99 | 1,882 |

Directory of \koala\CU\Chsm243\src\lib\flex (4 files)

| | | |
|---|---|---|
| flex.dsp | 21/06/99 | 2,958 |
| libmain.c | 17/06/99 | 282 |
| libyywrap.c | 17/06/99 | 197 |
| libyywrapX.c | 04/10/99 | 208 |

Directory of \koala\CU\Chsm243\src\lib\pjl (10 files)

| | | |
|---|---|---|
| Makefile | 21/06/99 | 3,429 |
| PJL.dsp | 21/06/99 | 3,249 |
| compiler.c | 04/10/99 | 9,151 |
| hash.c | 04/10/99 | 7,340 |
| hashpjw.c | 21/06/99 | 1,310 |
| itoa.c | 21/06/99 | 1,442 |
| link2.c | 21/06/99 | 1,147 |
| pt.c | 21/06/99 | 1,944 |
| registry.c | 21/06/99 | 4,386 |
| symbol.c | 04/10/99 | 5,046 |

Directory of \koala\CU\Chsm243\tests (19 files)

| | | |
|---|---|---|
| Makefile | 21/06/99 | 1,447 |
| dominance.chsm | 21/06/99 | 705 |
| enter_deep.chsm | 04/10/99 | 655 |
| enter_exit.chsm | 04/10/99 | 695 |
| enter_once.chsm | 04/10/99 | 1,158 |
| erroneous1.chsm | 04/10/99 | 754 |
| erroneous2.chsm | 04/10/99 | 753 |
| events1.chsm | 04/10/99 | 962 |
| events2.chsm | 04/10/99 | 1,352 |
| events3.chsm | 04/10/99 | 1,350 |
| events4.chsm | 04/10/99 | 939 |
| finite.chsm | 04/10/99 | 515 |
| history.chsm | 04/10/99 | 658 |
| infinite.chsm | 21/06/99 | 575 |
| internal.chsm | 04/10/99 | 371 |
| microstep1.chsm | 04/10/99 | 595 |
| microstep2.chsm | 04/10/99 | 742 |
| nondeterminism.chsm | 04/10/99 | 534 |
| precondition.chsm | 21/06/99 | 858 |

Directory of \Visio (3 files)

| | | |
|---|---|---|
| KOALA StateCharts.vst | 21/08/00 | 406,528 |
| KoalaStateChartsAddOn.vsl | 21/08/00 | 61,440 |
| Qi-UML Statechart.vss | 21/08/00 | 43,520 |

Note: The two compact discs labeled COPY-1 and COPY-2 are identical.

1. A method for simulating a communication system, comprising:
displaying a graphic representation of a state chart comprising a plurality of states and corresponding to a procedure followed by the communication system;
generating executable computer code responsive to the state chart, which code, when run by a simulator, causes the simulator to simulate the procedure; and
incorporating into the computer code one or more pointers so as to generate, while the simulator is simulating the procedure, an indication in the graphic representation of the state in which the simulator is running.

2. A method according to claim 1, wherein the communication system comprises a Base Station Controller (BSC) and comprising:
coupling a unit-under-test (UUT) to the simulator; and
conveying communications between the UUT and the simulator while the simulator is simulating the procedure of the BSC.

3. A method according to claim 2, wherein conveying the communications between the UUT and the simulator comprises operating the UUT responsive to the indication in the graphic representation.

4. A method according to claim 1, and comprising receiving a signal from the simulator and generating a display responsive to the signal on the monitor.

5. A method according to claim 1, wherein generating executable code comprises:
generating code automatically under control of operating instructions for a computing system; and
incorporating code generated by an operator of the communication system in the automatically generated code.

6. A method according to claim 1, wherein the state chart comprises a first state chart and a second state chart, and wherein displaying the graphic representation comprises:
displaying the first state chart; and
displaying the second state chart responsive to the indication displayed on the first start chart.

7. Apparatus for simulating a communication system, comprising:
a computing system, adapted to generate a graphic representation of a state chart comprising a plurality of states and corresponding to a procedure followed by the communication system, and which is further adapted to generate executable computer code responsive to the state chart and to incorporate one or more pointers indicative of respective one or more of the plurality of states in the code;
a simulator which is adapted to simulate the procedure responsive to the executable computer code, and to generate, responsive to the one or more pointers, an indication of the state in which the simulator is running; and
a monitor, which is coupled to the simulator so as to display the graphic representation with the indication of the state in which the simulator is running.

8. Apparatus according to claim 7, wherein the communication system comprises a Base Station Controller (BSC), and the simulator comprises a processor and a memory which are adapted to simulate operations of the BSC, and wherein the simulator is adapted to communicate with a unit-under-test (UUT) while simulating the procedure.

9. Apparatus according to claim 8, wherein the UUT is operated responsive to the indication of the state in which the simulator is running.

10. Apparatus according to claim 7, wherein the monitor is adapted to receive a signal from the simulator and to generate a display responsive to the signal on the monitor.

11. Apparatus according to claim 7, wherein the computing system is adapted to generate code automatically under control of operating instructions for the processor, and to incorporate code generated by an operator of the computing system in the automatically generated code.

12. Apparatus according to claim 7, wherein the state chart comprises a first state chart and a second state chart, and wherein the simulator is adapted to cause the monitor to display the first state chart and to display the second state chart responsive to the indication displayed on the first start chart.
